(19) United States
(12) Patent Application Publication
(10) Pub. No.: US 2012/0188598 A1
(43) Pub. Date: Jul. 26, 2012

(54) INFORMATION PROCESSING APPARATUS, CONTROL METHOD, AND COMPUTER-READABLE MEDIUM

(75) Inventor: Shiho Furuya, Tokyo (JP)

(73) Assignee: CANON KABUSHIKI KAISHA, Tokyo (JP)

(21) Appl. No.: 13/350,709

(22) Filed: Jan. 13, 2012

(30) Foreign Application Priority Data
Jan. 25, 2011 (JP) 2011-013374

(51) Int. Cl. G06K 15/02

(52) U.S. Cl. 358/1.15

(57) ABSTRACT

An information processing apparatus which communicates with a printer, comprises a print command generation unit configured to convert print data into a print command interpretable by the printer; a status command generation unit configured to generate a status command representing a generation status of the print command by the print command generation unit; a status command determination unit configured to determines the generation status of the print command based on the status command; and a status display unit configured to display the generation status of the print command that has been determined by the status command determination unit.

### BACKGROUND OF THE INVENTION

1. Field of the Invention

The present invention relates to an information processing apparatus, control method, and computer-readable medium in a printing system which prints based on input information. Particularly, the present invention relates to a technique of displaying information about the print data processing statuses of a printer and printer driver.

2. Description of the Related Art

There has conventionally been a technique of dynamically or sequentially displaying processing during execution in a printer among a series of processes from reception of image data to printing (for example, Japanese Patent Laid-Open No. 2002-120432). Japanese Patent Laid-Open No. 2002-120432 discloses that information representing processing during execution among a series of processes from reception of image data to printing is acquired, and the status information display unit of a printer is notified of it and displays it.

However, for example, the method in Japanese Patent Laid-Open No. 2002-120432 has a problem that when processing on the printer driver side takes time, the user cannot determine whether processing is proceeding normally or the printer cannot respond owing to generation of some internal error. If processing in the printer driver takes longer time than usual, the user feels anxious because the operation status in the printer driver cannot be seen from the outside. Especially when printing data contains a large-size image, print command generation processing for image data within a printing control apparatus may take longer time than usual.

### SUMMARY OF THE INVENTION

The present invention provides a printing system in which when it is detected that processing as mentioned above within a printing control apparatus will take longer time than usual, a message indicative of this is explicitly expressed as status information, thereby reassuring the user.

According to one aspect of the present invention, there is provided an information processing apparatus which communicates with a printer, comprising: a print command generation unit configured to convert print data into a print command interpretable by the printer; a status command generation unit configured to generate a status command representing a generation status of the print command by the print command generation unit; a status command determination unit configured to determines the generation status of the print command based on the status command; and a status display unit configured to display the generation status of the print command that has been determined by the status command determination unit.

According to another aspect of the present invention, there is provided a method of controlling an information processing apparatus which communicates with a printer, comprising: a print command generation step of converting print data into a print command interpretable by the printer; a status command generation step of generating a status command representing a generation status of the print command in the print command generation step; a status command determination step of determining the generation status of the print command based on the status command; and a status display step of displaying the generation status of the print command that has been determined in the status command determination step.

According to another aspect of the present invention, there is provided a computer-readable medium storing a program for causing a computer to function as a print command generation unit configured to convert print data into a print command interpretable by a printer, a status command generation unit configured to generate a status command representing a generation status of the print command by the print command generation unit, a status command determination unit configured to determine the generation status of the print command based on the status command, and a status display unit configured to display the generation status of the print command that has been determined by the status command determination unit.

According to the present invention, the user is notified of a message to this effect and can be reassured when it is detected that print command generation processing will take time.

Further features of the present invention will become apparent from the following description of exemplary embodiments (with reference to the attached drawings).

### BRIEF DESCRIPTION OF THE DRAWINGS

FIG. 1 is a block diagram showing the configuration of a printing system;

FIG. 2 is a block diagram showing the configuration of a printer driver;

FIG. 3 is a flowchart showing processing by a status information display unit and user interface module;

FIG. 4 is a flowchart showing processing by a print command generation unit;

FIG. 5 is a flowchart showing processing of estimating the print command generation time in the print command generation unit;

FIG. 6 is a flowchart showing command transmission processing by a command transmission/reception unit;

FIG. 7 is a flowchart showing processing by a status information determination unit;

FIG. 8 is a flowchart showing status determination processing based on data generation information;

FIGS. 9A, 9B, and 9C are views each showing a status information display screen;

FIG. 10 is a flowchart showing command transmission processing by the command transmission/reception unit;

FIG. 11 is a flowchart showing processing when the command transmission/reception unit receives a print processing start instruction;

FIG. 12 is a flowchart showing command transmission processing by the command transmission/reception unit;

FIG. 13 is a conceptual view showing the structure of a print command; and

FIG. 14 is a flowchart showing status determination processing based on data generation information.

### DESCRIPTION OF THE EMBODIMENTS

Embodiments of the present invention will now be described in detail with reference to the accompanying drawings. It is to be understood that the following embodiments are not intended to limit the claims of the present invention, and that not all combinations of features described in the embodiments are indispensable for the unit to solve the problems in the present invention.

[System Configuration]

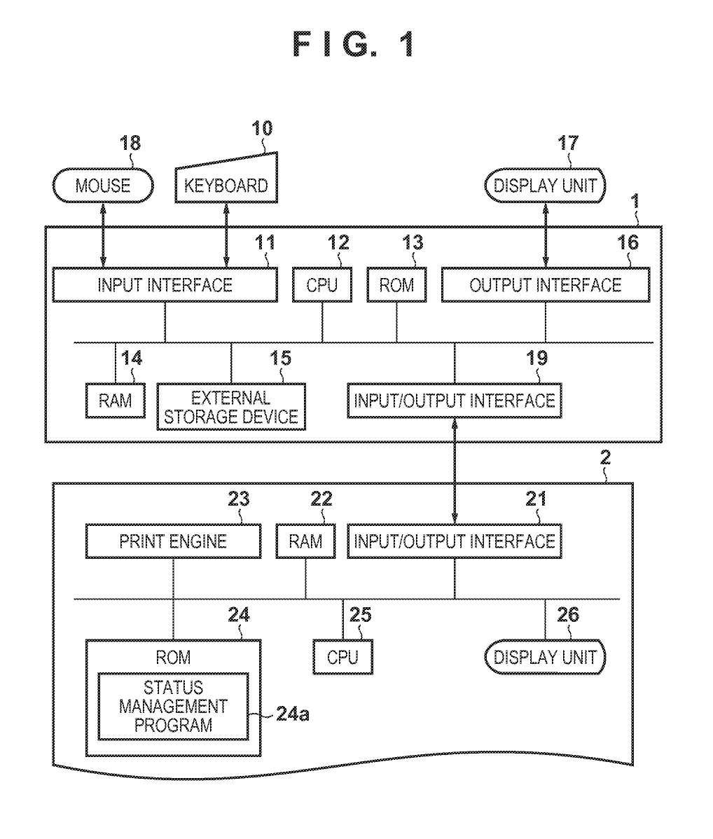

The configuration of a printing system including a printer and an information processing apparatus connected to the printer according to an embodiment will be explained with reference to the block diagram of FIG. 1. FIG. 1 shows a printing system including a printer 2 and an information processing apparatus 1 connected to the printer 2 according to the embodiment of the present invention. The information processing apparatus 1 includes an input interface 11, CPU 12, ROM 13, RAM 14, external storage device 15, output interface 16, display unit 17, keyboard 10, mouse 18, and input/output interface 19.

The ROM 13 stores an initialization program. The external storage device 15 saves application programs, an OS (Operating System), a printer driver, and various other data. The RAM 14 is used as a work memory for various programs stored in the external storage device 15.

The printer 2 includes an input/output interface 21, RAM 22, print engine 23, ROM 24, CPU 25, and display unit 26. The input/output interface 21 is connected to the input/output interface 19 of the information processing apparatus 1 via a connection interface (not shown). The embodiment assumes that the connection interface is a USB® interface, but the connection interface is arbitrary. Also, the input/output interface 21 can connect an expansion option for expanding the function of the printer 2. The RAM 22 is used as the main memory and work memory of the CPU 25, and serves as a reception buffer for temporarily saving a received print job and an area for saving various data.

The print engine 23 prints based on data saved in the RAM 22. The ROM 24 stores various control programs including a status management program 24a, and data used in the control programs. The CPU 25 controls the respective units of the printer 2 according to these control programs. The status management program 24a monitors the status of the printer 2 based on information about various sensors (not shown) within the printer, creates status information, and stores it in the RAM 22.

[Software Configuration]

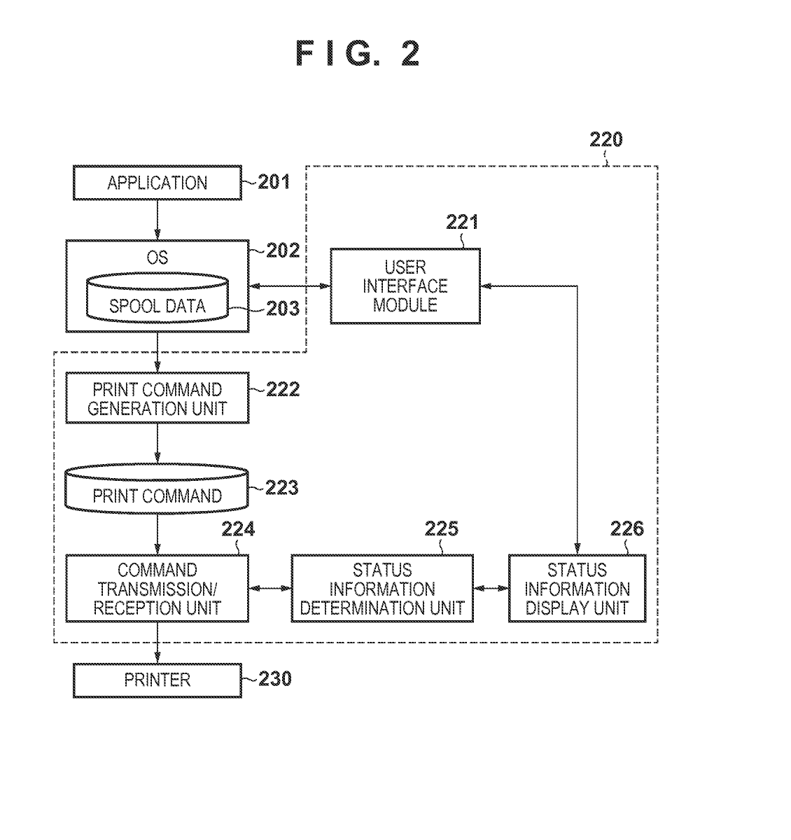

FIG. 2 is a block diagram exemplifying the configuration of software conceptually representing the OS and printer driver mainly in order to explain the configuration of the printer driver in the embodiment. An OS 202 temporarily stores, as spool data 203, print data created by an application 201. The OS 202 supplies the temporarily stored spool data 203 as print data to a printer driver 220. Upon receiving a printing start notification from the OS 202, a user interface module 221 activates a status information display unit 226.

A print command generation unit 222 of the printer driver 220 converts print data into a print command 223 interpretable by a printer 230 (printer 2). A command transmission/reception unit 224 sequentially transmits the print commands 223 to the printer 230. When the user should be notified of the status of the printer 230, for example, when an error has occurred in the printer 230, the command transmission/reception unit 224 issues an error status display instruction to the status information display unit 226.

The status information display unit 226 analyzes the status of the printer 230 using a status information determination unit 225, and displays information about the printer 230 on the display unit 17 of the information processing apparatus 1. This provides a unit for allowing the user to confirm the status of the printer 230. The printer 230 analyzes its status according to the status management program 24a, and displays information about the printer 230 on the display unit 26. This provides a unit for allowing the user to confirm the status of the printer 230.

### First Embodiment

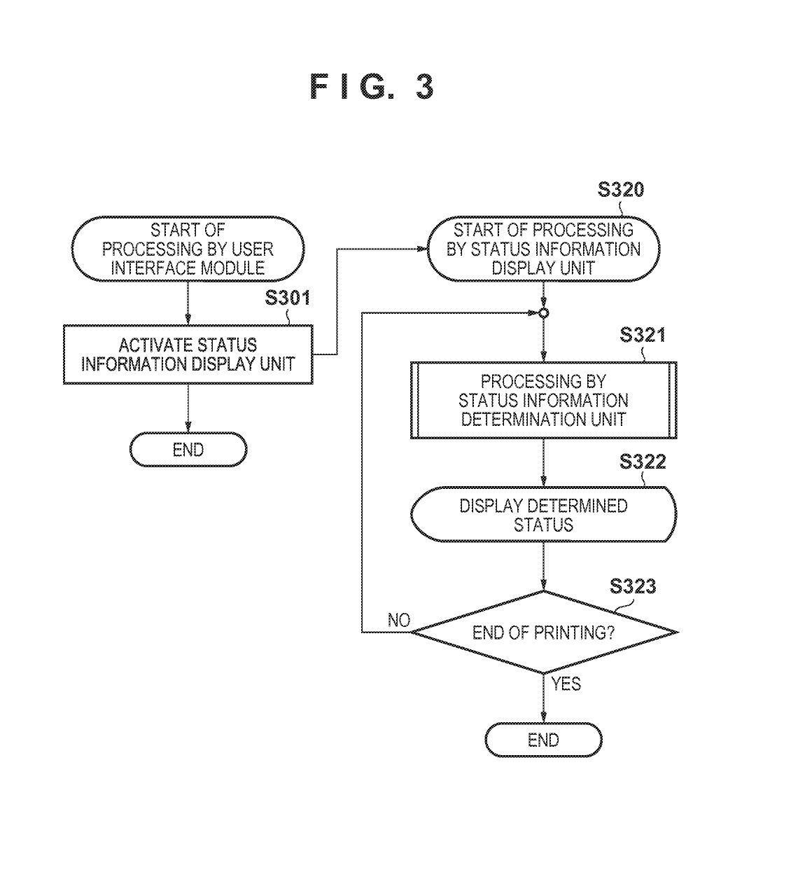

The first embodiment according to the present invention will be described in detail with reference to FIGS. 3 to 9C.

FIG. 3 is a flowchart showing processing by a user interface module 221 and status information display unit 226. In the embodiment, this processing is implemented by executing, by a CPU 12, a program stored in a ROM 13 or the like serving as a storage unit. Upon receiving a printing start notification from an OS 202, the user interface module 221 activates the status information display unit 226 (step S301).

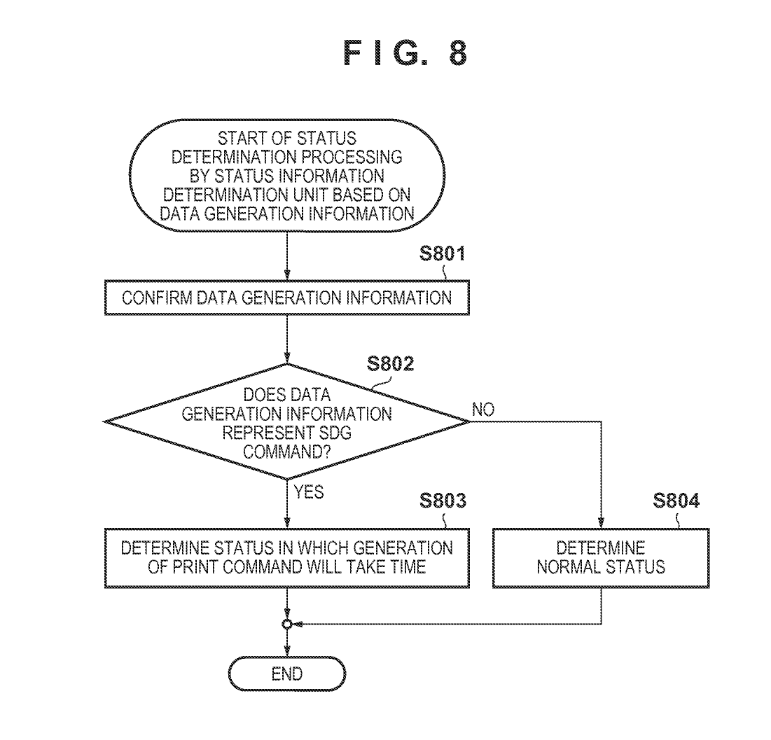

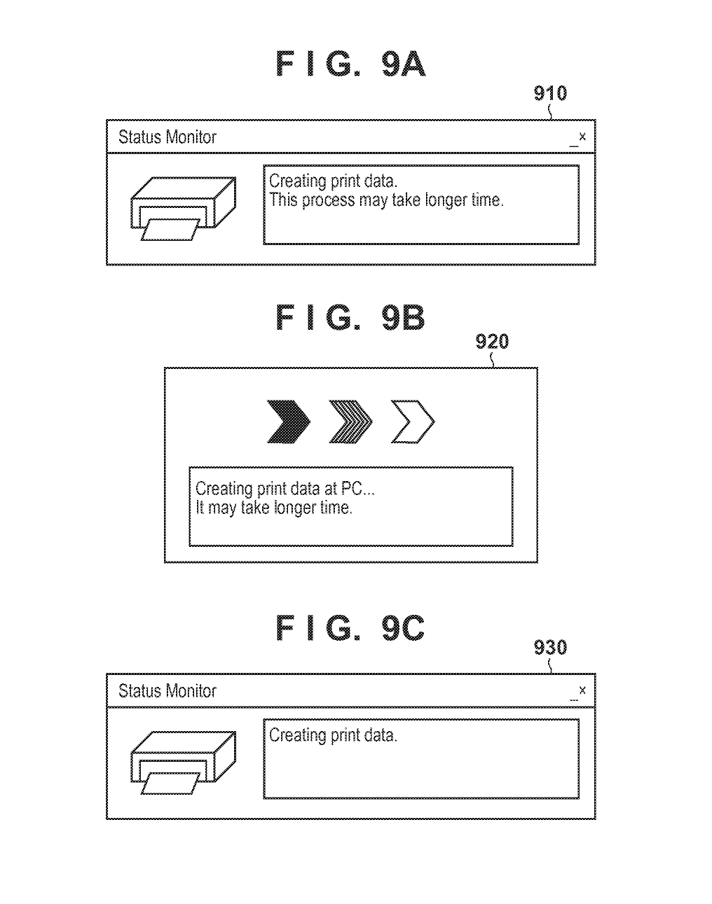

After the start of processing (step S320), the status information display unit 226 calls a status information determination unit 225 (step S321). Processing by the status information determination unit 225 will be described later with reference to FIG. 8. The status information display unit 226 displays a status information display screen 910 as shown in FIG. 9A on a display unit 17 of an information processing apparatus 1. The status information display unit 226 displays a status determined in step S321 so that the user can clearly understand that, for example, generation of a print command will take time (step S322). The status information display unit 226 keeps displaying the status till the end of printing (YES in step S323).

[Command Generation Processing]

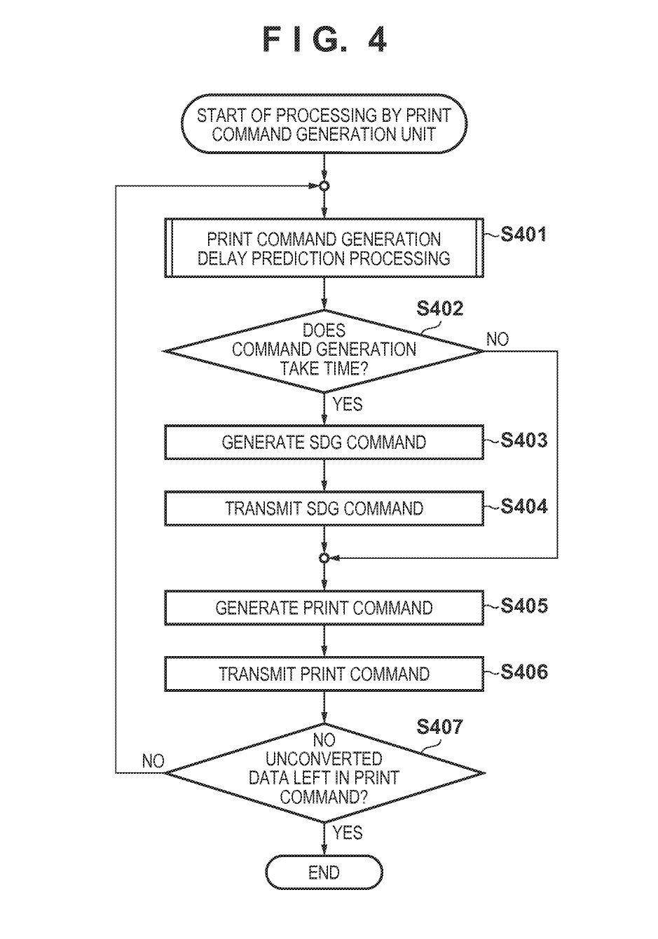

FIG. 4 is a flowchart showing processing by a print command generation unit 222. In the embodiment, this processing is implemented by executing, by the CPU 12, a program stored in the ROM 13 or the like serving as a storage unit. Upon receiving a printing start notification from the OS 202, the print command generation unit 222 starts processing. Generation of a print command, which is also called despool processing, corresponds to processing of performing various general image processes for spooled print data and converting the print data into a print command 223 interpretable by a printer 230 (printer 2).

For example, red (R), green (G), and blue (B) print data each of 8 bits (256 tone levels) are finally output as cyan (C), magenta (M), yellow (Y), and black (K) bit image data each of 1 bit. More specifically, R, G, and B luminance data each of 8 bits are converted into R′, G′, and B′ data each of 8 bits by the first color conversion processing using a 3D lookup table (LUT).

In the embodiment, color conversion processing from R, G, and B data into R′, G′, and B′ data corresponds to the following processes: processing of correcting the difference between the color space of an input image represented by luminance data and a color space reproducible by the printer; color space conversion processing of converting the color space of an input image represented by R, G, and B luminance data into a device-independent XYZ color space; and processing of converting the device-independent color space into a printer-dependent color space. The processing is performed using a 3D LUT as described above. However, the LUT does not have grid points for all input combinations, and interpolation processing is adopted.

The R′, G′, and B′ data each of 8 bits obtained by the color conversion processing are converted into C, M, Y, and K data each of 8 bits by subsequent processing using a 3D LUT. The second color conversion processing includes processing of converting R, G, and B data of an input system expressed by luminance signals into C, M, Y, and K data of an output system expressed by density signals, and other processes such as masking, under color removal, and black generation.

The C, M, Y, and K data each of 8 bits obtained by the second color conversion processing using the LUT undergo output gamma correction using 1D LUTs for the respective colors. This processing is executed because the number of dots to be printed per unit area of a printing medium and an output characteristic such as reflection density obtained by measuring the number of dots do not have a linear relationship in general. The output gamma correction can guarantee a linear relationship between the C, M, Y, and K input tone levels each of 8 bits and the density levels of a printed image.

After the output gamma correction, binarization processing is done. Since the printer in the embodiment is a binary printer, the obtained C, M, Y, and K data each of 8 bits are quantized into C, M, Y, and K data each of 1 bit.

The above-described image processing is a general one. In addition, in the embodiment, print data may contain data necessary to be decoded, and decoding processing may be performed as another image processing in generation of a print command. Examples of data necessary to be decoded are data in which a digital watermark is added to an image, and encrypted print data. For these data, decoding modules are arranged, determination modules for specifying a target region are arranged at all necessary portions, and then target pixels need to be decoded. Processing for these pieces of information generally requires longer time.

To estimate the time taken for this processing, the print command generation unit 222 performs print command generation delay prediction processing to determine whether conversion processing into the print command 223 takes time (step S401).

[Print Command Generation Delay Prediction Processing]

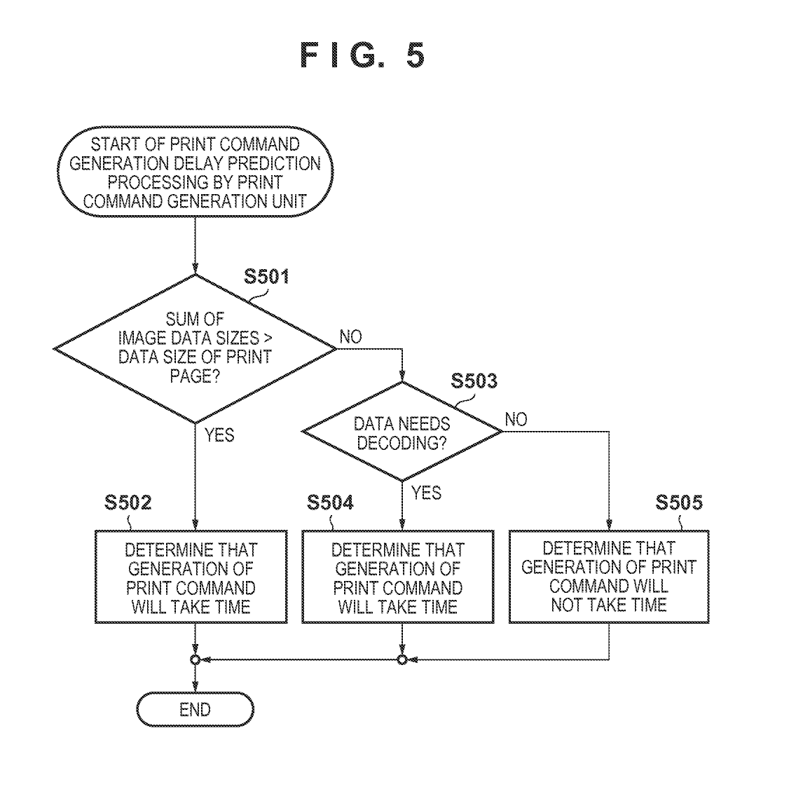

Print command generation delay prediction processing in step S401 of FIG. 4 will be explained with reference to FIG. 5. The print command generation delay prediction processing starts in response to a call from the print command generation unit 222. In the print command generation delay prediction processing, a print command generation delay is predicted by collating the contents of spool data 203 with conditions defined in advance to determine that generation of a print command will take time. In the print command generation delay prediction processing, it is determined whether the sum of the sizes of image data contained in the spool data 203 is larger than the data size of a print page (step S501).

For example, in A4-size printing, the data size of a print page is about 100 MB. When the spool data 203 contains image data of a larger size, it can be predicted that generation of a print command will take time. Hence, if it is determined that the sum of the sizes of image data contained in the spool data 203 is larger than the data size of a print page (YES in step S501), it is determined that generation of a print command will take time (step S502). If it is determined that the sum of the sizes of image data contained in the spool data 203 is equal to or smaller than the size of a print page (NO in step S501), it is determined in the print command generation delay prediction processing whether the print data requires decoding processing (step S503). This determination is made based on the presence/absence of a digital watermark or the like, as described above.

If it is determined that the print data requires decoding processing (YES in step S503), it is determined that generation of a print command will take time (step S504). If it is determined that the print data does not require decoding processing (NO in step S503), it is determined that generation of a print command will not take time (step S505). Note that the above-described determination conditions (steps S501 and S503) are merely examples and are not indispensable determination conditions. Other determination conditions can be defined and used in accordance with the type and format of print data.

Based on the result of print command generation delay prediction processing (step S401), the print command generation unit 222 generates a status command. More specifically, if it is determined that generation of the print command 223 will take time (YES in step S402), the print command generation unit 222 generates a status command representing that data generation of a print command will take time (generation status) (step S403). Note that a status command generated here will be called a “SlowDataGeneration (to be simply referred to as SDG) command”. This implements a status command generation unit. The print command generation unit 222 transmits the status command to a command transmission/reception unit 224 (step S404). If the print command generation unit 222 determines, based on the result of step S401, that generation of the print command 223 will not take time (NO in step S402), it advances to the next processing (step S405) without generating the SDG command.

The print command generation unit 222 converts the spool data 203 into the print command 223 interpretable by the printer 230 (step S405), and transmits the generated print command 223 (step S406). Respective commands to be transmitted in step S406 are temporarily saved in a cache memory ensured in a RAM 14 for the OS 202, and properly transferred by the OS 202 to the command transmission/reception unit 224.

The print command generation unit 222 repetitively executes steps S401 to S406, and if it determines that all print data have been converted (YES in step S407), the process ends. By this processing, when generation of the print command 223 may take time, the SDG command can be generated to notify the user in advance that generation of a print command will take time in subsequent processing.

[Command Transmission Processing]

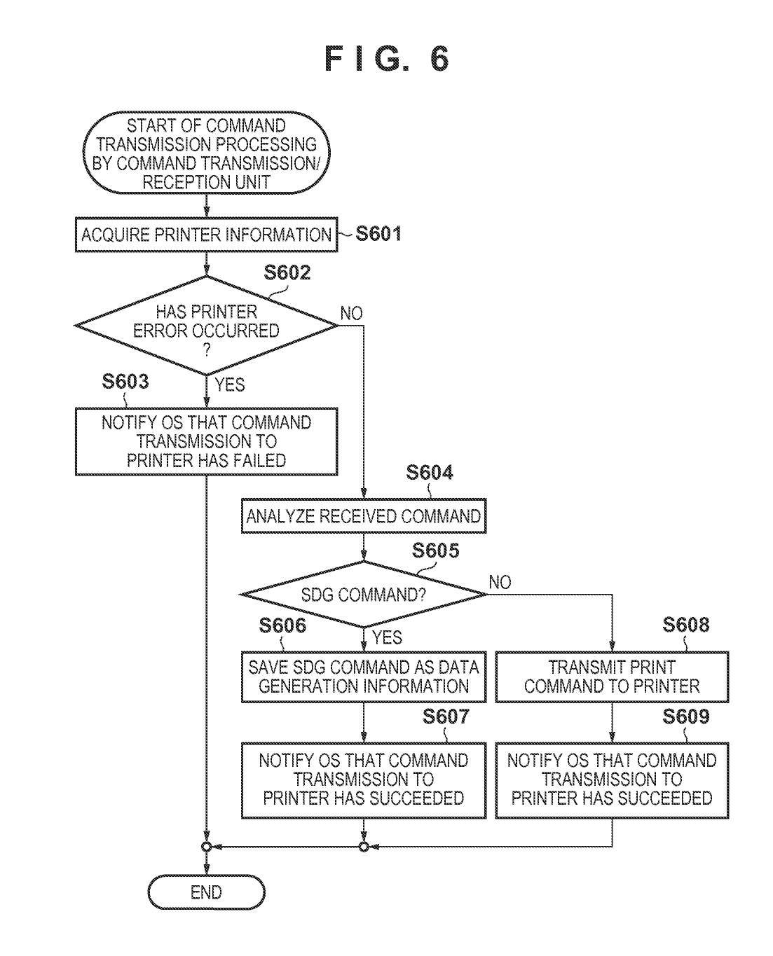

Processing when the command transmission/reception unit 224 transmits a command to the printer 230 will be explained in detail with reference to FIG. 6. In the embodiment, this processing is implemented by executing, by the CPU 12, a program stored in the ROM 13 or the like serving as a storage unit. The command transmission/reception unit 224 receives the print command 223 and SDG command from the OS 202. At the same time, the command transmission/reception unit 224 receives, from the OS 202, a command transmission instruction to the printer 230, and starts transmission processing.

The command transmission/reception unit 224 acquires the status of the printer 230 as printer information, and saves it in an external storage device 15 (step S601). In the embodiment, every time a write instruction to the printer 230 is received, the status of the printer 230 is acquired. However, the present invention is not limited to this configuration, and a printer information acquisition thread may be created so that processing of acquiring the status of the printer 230 is executed as a thread different from the command transmission/reception unit 224.

In this printer information acquisition thread, the status of the printer 230 is acquired at a predetermined interval, and every acquired status of the printer 230 is saved in the external storage device 15. After the start, the command transmission/reception unit 224 refers to the status of the printer 230 that has been saved in the external storage device 15. The command transmission/reception unit 224 analyzes the status acquired in step S601, and determines whether an error has occurred in the printer 230 (step S602). If the command transmission/reception unit 224 determines that an error has occurred in the printer 230 (YES in step S602), it does not actually perform command transmission processing to the printer 230, but notifies the OS 202 that command transmission to the printer 230 has failed (step S603). Upon receiving the notification that command transmission has failed, the OS 202 keeps notifying the command transmission/reception unit 224 of the same print command 223 until transmission becomes successful.

The command transmission/reception unit 224 analyzes the command which has been received from the OS 202 and is to be transmitted to the printer 230 (step S604) if it determines that no error has occurred in the printer 230 (NO in step S602). If the analyzed command is the SDG command (YES in step S605), the command transmission/reception unit 224 saves, as “data generation information” in the external storage device 15, the determination result representing that the analyzed command is the SDG command (step S606).

The data generation information is information to be transferred to the status information display unit 226. As a method for interprocess communication between the command transmission/reception unit 224 and the status information display unit 226, the embodiment will exemplify Bidi Printer Communication (bidi communication) laid open to the public by Microsoft Developer Network (MSDN®).

Although the command transmission/reception unit 224 does not actually transmit a command to the printer 230, it notifies the OS 202 that command transmission to the printer 230 has succeeded (step S607). In response to this, the OS 202 deletes the SDG command from the cache memory ensured in the RAM 14.

If the command transmission/reception unit 224 determines that the command analyzed in step S604 is not the SDG command (NO in step S605), it transmits, to the printer 230, the print command 223 received from the OS 202 (step S608). The command transmission/reception unit 224 notifies the OS 202 that command transmission processing to the printer 230 has succeeded (step S609).

[Status Information Determination Processing]

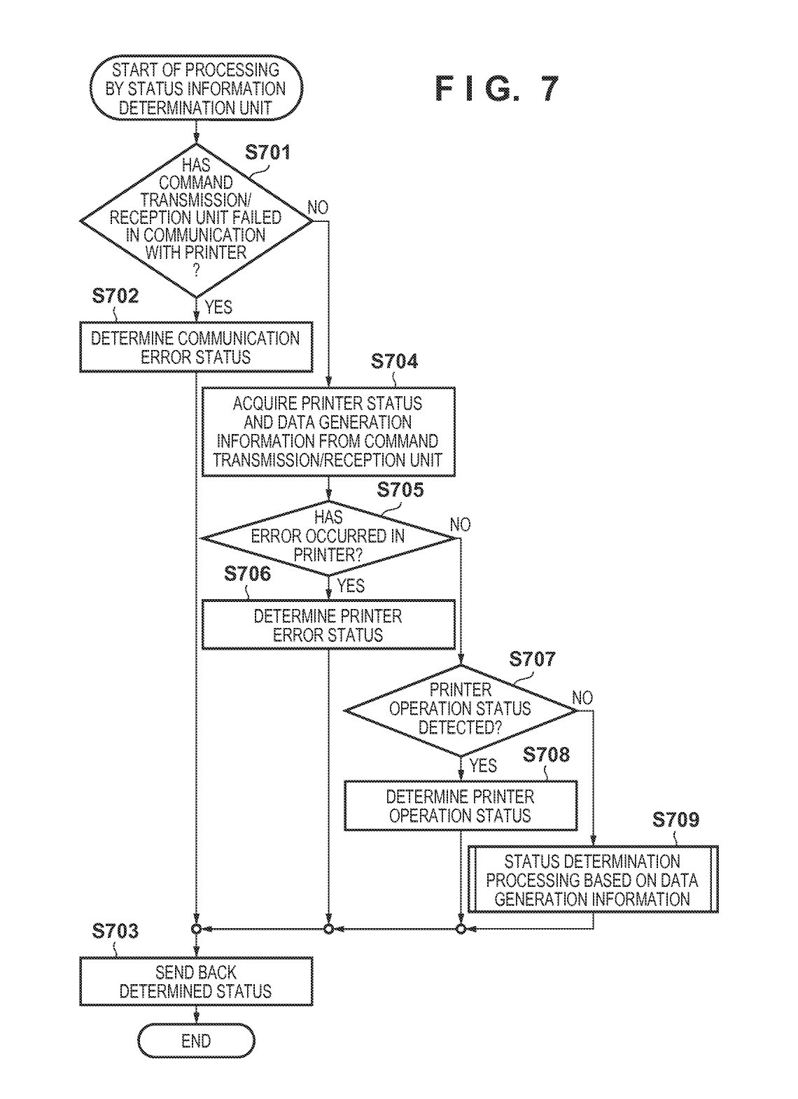

Processing by the status information determination unit 225 will be explained in detail with reference to FIG. 7. The status information determination unit 225 starts processing in response to a call from the status information display unit 226 (step S321).

The status information determination unit 225 determines whether the command transmission/reception unit 224 has established communication with the printer 230 (step S701). If the status information determination unit 225 determines that communication with the printer 230 has failed (YES in step S701), it determines that a communication error status has occurred (step S702). The status information determination unit 225 sends back the determined status to the status information display unit 226 (step S703).

If the status information determination unit 225 determines that communication between the command transmission/reception unit 224 and the printer 230 is successful (NO in step S701), it acquires, from the command transmission/reception unit 224 by bidi communication, the status of the printer 230 and the data generation information which have been saved (step S704). The status information determination unit 225 determines, from the acquired status of the printer 230, whether an error has occurred in the printer 230 (step S705). If the status information determination unit 225 determines that an error has occurred in the printer 230 (YES in step S705), it determines that a printer error status has occurred (step S706). The status information determination unit 225 sends back the determined status to the status information display unit 226 (step S703).

If the status information determination unit 225 determines that no error has occurred in the printer 230 (NO in step S705), it determines whether the printer 230 is in a status indicating an operation such as printing (step S707). If the status information determination unit 225 determines that the printer 230 is executing an operation such as printing (YES in step S707), it determines that a printer operation status has occurred (step S708). The status information determination unit 225 sends back the determined status to the status information display unit 226 (step S703).

If the status information determination unit 225 determines that the printer 230 is not in any operation status (NO in step S707), it starts processing of determining a status based on the data generation information acquired in step S704 (step S709). After status determination processing in step S709, the status information determination unit 225 sends back the determined status to the status information display unit 226 (step S703).

FIG. 8 is a flowchart showing the above-mentioned processing (step S709) of determining a status based on data generation information. After the start of processing in response to a call in step S709, the status information determination unit 225 refers to the data generation information acquired in step S704 (step S801). The status information determination unit 225 determines whether the acquired data generation information represents the SDG command (step S802). If the acquired data generation information represents the SDG command (YES in step S802), the status information determination unit 225 determines that a status in which generation of a print command will take time has occurred (step S803).

If the acquired data generation information does not represent that data generation will take time (NO in step S802), the status information determination unit 225 determines that the printer 230 and print command generation unit 222 are in a normal status (step S804). The process then ends. This implements a status command determination unit.

Based on the processing result, the status information display unit 226 displays the status information display screen 910 as shown in FIG. 9A on the display unit 17 of the information processing apparatus 1, and displays the status determined by the status information determination unit 225 (step S322).

More specifically, as described above, if it is determined that a printer error status has occurred (step S706), the status information display unit 226 displays a status representing a printer error. If it is determined that the printer 230 is executing an operation such as printing (step S708), the status information display unit 226 displays a status representing a printer operation in progress. If not so, the status information display unit 226 can display a status so that the user can clearly understand that generation of a print command will take time, which has been determined in step S803 (step S322).

By the above-described configuration, when it is predicted based on the contents of the spool data 203 that generation of a print command will take time, the user can be notified of a message to this effect.

### Second Embodiment

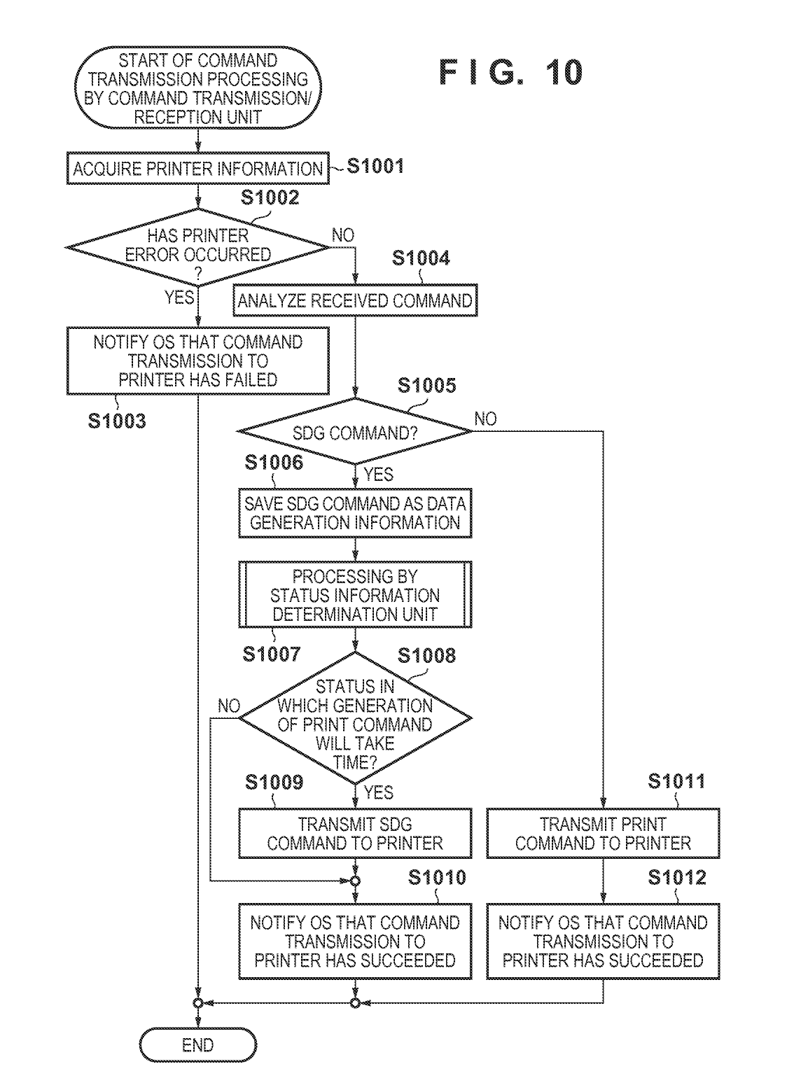

The second embodiment according to the present invention will be described with reference to FIG. 10. In the first embodiment, the information processing apparatus 1 notifies the user that generation of the print command 223 will take time. In the second embodiment, a printer 2 gives the same notification.

[Command Transmission Processing]

FIG. 10 is a flowchart showing processing when a command transmission/reception unit 224 receives, from an OS 202, a command transmission instruction to a printer 230. In the embodiment, this processing is implemented by executing, by a CPU 12, a program stored in a ROM 13 or the like serving as a storage unit. The command transmission/reception unit 224 receives a print command 223 and SDG command from the OS 202. At the same time, the command transmission/reception unit 224 receives, from the OS 202, a command transmission instruction to the printer 230, and starts transmission processing. Note that a processing sequence up to reception of the print command 223 and SDG command is almost the same as that described in the first embodiment, and a description thereof will not be repeated.

The command transmission/reception unit 224 acquires the status of the printer 230 and saves it in an external storage device 15 (step S1001). In the embodiment, every time a write instruction to the printer 230 is received, the status of the printer 230 is acquired. However, a printer information acquisition thread may be created so that processing of acquiring the status of the printer 230 is executed as a thread different from the command transmission/reception unit 224. In this printer information acquisition thread, the status of the printer 230 is acquired at a predetermined interval, and every acquired status of the printer 230 is saved in the external storage device 15. In the embodiment, after this processing sequence starts, the command transmission/reception unit 224 refers to the status of the printer 230 that has been saved in the external storage device 15.

The command transmission/reception unit 224 analyzes the status acquired in step S1001, and determines whether an error has occurred in the printer 230 (step S1002). If the command transmission/reception unit 224 determines that an error has occurred in the printer 230 (YES in step S1002), it does not perform command transmission processing to the printer 230, and notifies the OS 202 that command transmission to the printer 230 has failed (step S1003). Upon receiving the notification that command transmission has failed, the OS 202 keeps notifying the command transmission/reception unit 224 of the same print command 223 until transmission becomes successful.

If the command transmission/reception unit 224 determines that no error has occurred in the printer 230 (NO in step S1002), it analyzes the command received from the OS 202 (step S1004). At this time, the command transmission/reception unit 224 determines whether the command analyzed in step S1004 is the SDG command (step S1005). If the command transmission/reception unit 224 determines that the command analyzed in step S1004 is the SDG command (YES in step S1005), it saves, as “data generation information” in the external storage device 15, the determination result representing that the analyzed command is the SDG command (step S1006).

The data generation information is information to be transferred to a status information display unit 226. As a method for interprocess communication between the command transmission/reception unit 224 and the status information display unit 226, the second embodiment will exemplify bidi communication, similar to the first embodiment. By processing (step S1007) of a status information determination unit 225, the command transmission/reception unit 224 acquires a status of which the user should be notified now. The processing (step S1007) by the status information determination unit 225 is the same as the processes in FIGS. 7 and 8 described in the first embodiment.

The command transmission/reception unit 224 determines whether the status acquired in step S1007 is a status in which generation of a print command will take time (step S1008). If the acquired status is a status in which generation of a print command will take time (YES in step S1008), the command transmission/reception unit 224 transmits the SDG command to the printer 230 (step S1009). Then, the command transmission/reception unit 224 notifies the OS 202 that command transmission to the printer 230 is successful (step S1010).

If the acquired status is not a status in which generation of a print command will take time (NO in step S1008), the command transmission/reception unit 224 does not transmit the SDG command to the printer 230. Although the command transmission/reception unit 224 does not actually transmit a command to the printer 230, it notifies the OS 202 that command transmission to the printer 230 is successful (step S1010). In response to this, the OS 202 deletes the SDG command from a cache memory ensured in a RAM 14.

As described above, by adding determination processing in step S1008 to the configuration, the SDG command can be transmitted to the printer 230 only when an information processing apparatus 1 displays a message that generation of a print command will take time. Thus, the display contents on a display unit 26 of the printer 230 can be synchronized with those on the information processing apparatus 1.

If the command analyzed in step S1004 is not the SDG command (NO in step S1005), the command transmission/reception unit 224 transmits, to the printer 230, the print command 223 received from the OS 202 (step S1011). The command transmission/reception unit 224 notifies the OS 202 that command transmission processing to the printer 230 is successful (step S1012). Upon receiving the SDG command from the command transmission/reception unit 224, the printer 230 displays, on a status information display screen 920 as shown in FIG. 9B that is displayed on the display unit 26, a message that data generation processing in the information processing apparatus 1 takes time.

By the above-described configuration, when it is determined based on the contents of the spool data 203 that generation of a print command will take time, the user can be notified of a message indicative of this not only on a display unit 17 of the information processing apparatus 1 but also on the display unit 26 of the printer 230. For example, when data is output to a network-connected remote printer, the user can recognize, on the printer display unit, that data generation takes time. The second embodiment therefore improves user convenience. The second embodiment also has an effect of synchronizing the display contents on the display unit 17 of the information processing apparatus 1 and those on the display unit 26 of the printer 230.

### Third Embodiment

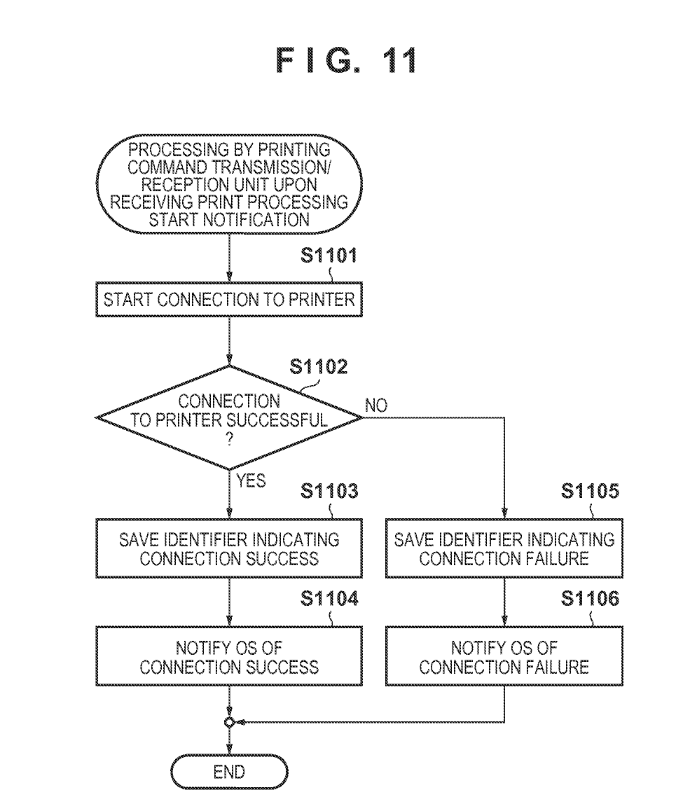

The third embodiment according to the present invention will be described with reference to FIGS. 11 to 14. In the first and second embodiments, the information processing apparatus 1 uses the SDG command to notify the user that generation of the print command 223 will take time. However, notification of the SDG command may take time. In the third embodiment, when it is determined that a print command 223 contains a print job to be converted and printer driver processing has started, it is determined that a print command generation unit 222 is generating the print command 223, and the user is notified of this status, instead of using the SDG command. Further, in the third embodiment, the notification contents change depending on whether the print command generation unit 222 has sent the SDG command. It is displayed whether print command generation processing will be completed smoothly or will take longer time than usual. From the display, the user can recognize the status.

[Connection Processing]

FIG. 11 is a flowchart showing processing when a command transmission/reception unit 224 receives a printing start notification from an OS 202. In the embodiment, this processing is implemented by executing, by a CPU 12, a program stored in a ROM 13 or the like serving as a storage unit. Upon receiving a printing notification from the OS 202, the command transmission/reception unit 224 starts the processing.

First, the command transmission/reception unit 224 tries a connection to a printer 230 (step S1101). Then, the command transmission/reception unit 224 determines whether a connection to the printer 230 is successful and the command transmission/reception unit 224 is connected to the printer 230 (step S1102). If the command transmission/reception unit 224 determines that a connection to the printer 230 is successful (YES in step S1102), it saves, in an external storage device 15, an identifier indicating connection success (step S1103). This implements a connection determination unit. The command transmission/reception unit 224 notifies the OS 202 that a connection to the printer 230 is successful (step S1104). The processing sequence then ends.

If the command transmission/reception unit 224 determines that a connection to the printer 230 has failed (NO in step S1102), it saves, in the external storage device 15, an identifier indicating a connection failure (step S1105). The command transmission/reception unit 224 notifies the OS 202 that a connection to the printer 230 has failed (step S1106). The processing sequence then ends.

This processing is performed only when a printing start notification is received from the OS 202. The identifiers saved in steps S1103 and S1105 can be used to determine whether processing by a printer driver 220 has started.

[Command Transmission Processing]

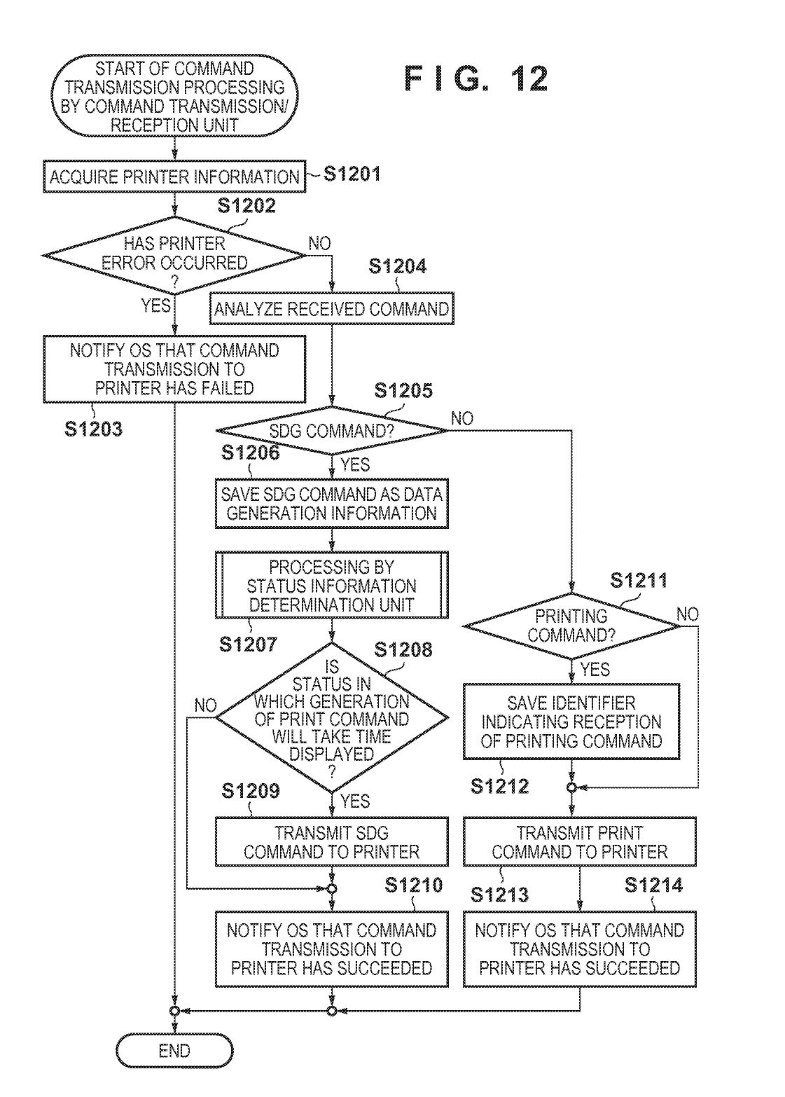

FIG. 12 is a flowchart showing processing when the command transmission/reception unit 224 receives, from the OS 202, a command transmission instruction to the printer 230. In the embodiment, this processing is implemented by executing, by the CPU 12, a program stored in the ROM 13 or the like serving as a storage unit. The command transmission/reception unit 224 receives the print command 223 and SDG command from the OS 202. At the same time, the command transmission/reception unit 224 receives, from the OS 202, a command transmission instruction to the printer 230, and starts transmission processing. Note that processing up to reception of the print command 223 and SDG command is the same as that described in the first embodiment, and a description thereof will not be repeated.

The command transmission/reception unit 224 acquires the status of the printer 230 and saves it in the external storage device 15 (step S1201). In the embodiment, every time a write instruction to the printer 230 is received, the status of the printer 230 is acquired. However, a printer information acquisition thread may be created so that processing of acquiring the status of the printer 230 is executed as a thread different from the command transmission/reception unit 224. In this printer information acquisition thread, the status of the printer 230 is acquired at a predetermined interval, and every acquired status of the printer 230 is saved in the external storage device 15. After this processing starts, the command transmission/reception unit 224 refers to the status of the printer 230 that has been saved in the external storage device 15.

The command transmission/reception unit 224 analyzes the status acquired in step S1201 and determines whether an error has occurred in the printer 230 (step S1202). If the command transmission/reception unit 224 determines that an error has occurred in the printer 230 (YES in step S1202), it does not perform command transmission processing to the printer 230, and notifies the OS 202 that command transmission to the printer 230 has failed (step S1203). Upon receiving the notification that command transmission has failed, the OS 202 keeps notifying the command transmission/reception unit 224 of the same print command 223 until transmission succeeds. That is, when a printer error has occurred, a message indicative of this is displayed preferentially to another status display.

If the command transmission/reception unit 224 determines that no error has occurred in the printer 230 (NO in step S1202), it analyzes the command which has been received from the OS 202 and is to be transmitted to the printer 230 (step S1204). Then, the command transmission/reception unit 224 determines whether the command analyzed in step S1204 is the SDG command (step S1205). If the command transmission/reception unit 224 determines that the command analyzed in step S1204 is the SDG command (YES in step S1205), it saves, as “data generation information” in the external storage device 15, the determination result representing that the analyzed command is the SDG command (step S1206).

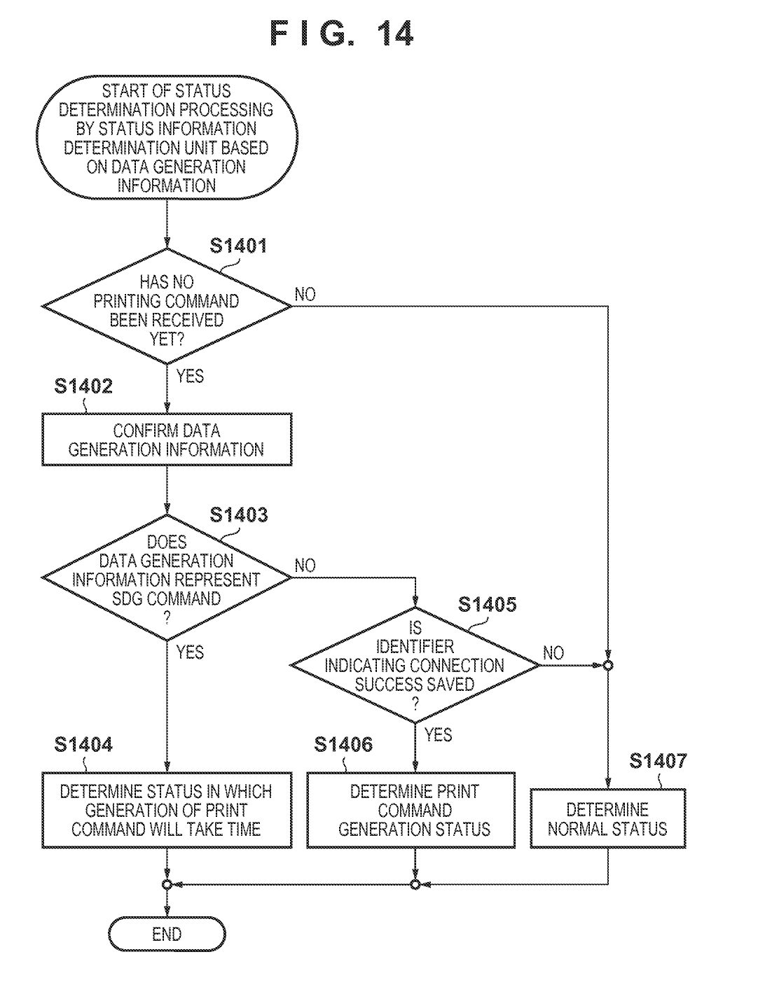

The data generation information is information to be transferred to a status information display unit 226. As a method for interprocess communication between the command transmission/reception unit 224 and the status information display unit 226, the embodiment will exemplify bidi communication. By processing (step S1207) of a status information determination unit 225, the command transmission/reception unit 224 acquires a status of which the user should be notified now. The processing (step S1207) by the status information determination unit 225 will be described later with reference to FIG. 14.

The command transmission/reception unit 224 determines whether the status acquired in step S1207 is a status in which generation of a print command will take time (step S1208). If the acquired status is a status in which generation of a print command will take time (YES in step S1208), the command transmission/reception unit 224 transmits the SDG command to the printer 230 (step S1209). Then, the command transmission/reception unit 224 notifies the OS 202 that command transmission to the printer 230 is successful (step S1210).

If the acquired status is not a status in which generation of a print command will take time (NO in step S1208), the command transmission/reception unit 224 does not transmit the SDG command to the printer 230. Although the command transmission/reception unit 224 does not actually transmit a command to the printer 230, it notifies the OS 202 that command transmission to the printer 230 is successful (step S1210). Then, the OS 202 deletes the SDG command from a cache memory ensured in a RAM 14. If the command transmission/reception unit 224 determines that the command analyzed in step S1204 is not the SDG command (NO in step S1205), it determines whether the command analyzed in step S1204 is a printing command (step S1211).

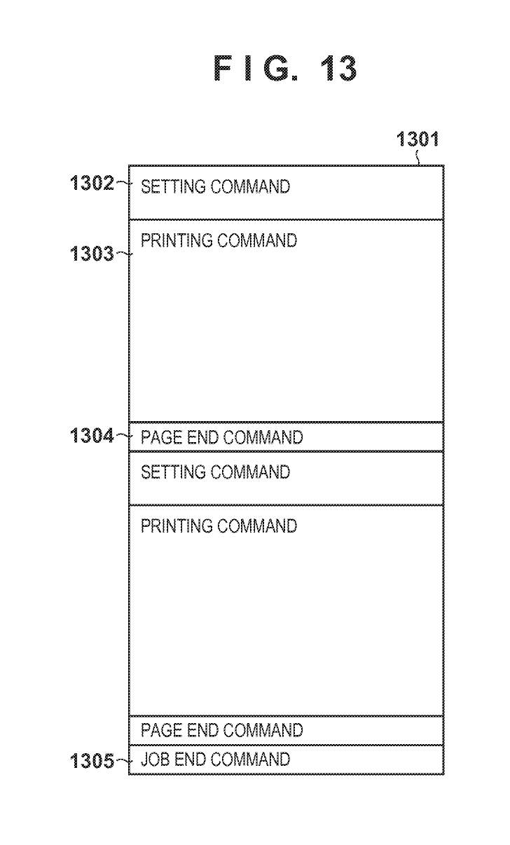

The structure of the print command will be explained with reference to FIG. 13. A print command 1301 is formed from a setting command 1302, printing command 1303, page end command 1304, and job end command 1305. The setting command 1302 is a command indicating print information of a print job. The print information contains, for example, the paper size, paper type, and whether to execute double-sided printing. The printing command 1303 is a command containing contents to be output by the printer 230, such as image data. Upon receiving the printing command 1303, the printer 230 performs a paper feed operation and starts printing. The page end command 1304 is a command added at the end of each page of a job. Based on the page end command 1304, the printer 230 can determine a page break. The job end command 1305 is a command added after the page end command of the final page of a job. Upon receiving the job end command 1305, the printer 230 ends printing.

If the command transmission/reception unit 224 determines that the command analyzed in step S1204 is the printing command 1303 (YES in step S1211), it saves, in the external storage device 15, an identifier indicating reception of the printing command 1303 (step S1212). After that, the command transmission/reception unit 224 transmits the printing command 1303 to the printer 230 (step S1213). The command transmission/reception unit notifies the OS 202 that command transmission processing to the printer 230 is successful (step S1214). This implements a reception determination unit.

If the command transmission/reception unit 224 determines that the command analyzed in step S1204 is not the printing command 1303 (NO in step S1211), it transmits the setting command 1302 to the printer 230 (step S1213). The command transmission/reception unit 224 notifies the OS 202 that command transmission processing to the printer 230 is successful (step S1214).

[Status Determination Processing]

FIG. 14 is a flowchart showing processing of determining a status by the status information determination unit 225 based on data generation information. In the embodiment, this processing is implemented by executing, by the CPU 12, a program stored in the ROM 13 or the like serving as a storage unit. Processing of determining a status based on data generation information is executed in step S709 of FIG. 7 described in the first embodiment.

After the start of processing, the status information determination unit 225 refers to an identifier saved in the external storage device 15 in step S1212, and determines whether the command transmission/reception unit 224 has received the printing command 1303 (step S1401). If the status information determination unit 225 determines that the printing command 1303 has been received (NO in step S1401), it determines that the printer 230 and print command generation unit 222 are in a normal status (step S1407). Then, the process ends.

If the status information determination unit 225 determines that the printing command 1303 has not been received yet (YES in step S1401), it refers to the data generation information acquired in step S704 (step S1402). The status information determination unit 225 determines whether the acquired data generation information represents that data generation will take time (step S1403). If the data generation information represents the SDG command (YES in step S1403), the status information determination unit 225 determines that a status in which generation of a print command will take time has occurred (step S1404). If it is determined in step S1404 that a status in which generation of a print command will take time has occurred, a status (for example, a status information display screen 910 shown in FIG. 9A) is displayed so that the user can clearly understand that generation of a print command will take time.

If the acquired data generation information does not represent the SDG command (NO in step S1403), the status information determination unit 225 refers to the identifiers which have been saved in the external storage device 15 in steps S1103 and S1105. The status information determination unit 225 determines whether the command transmission/reception unit 224 has established a connection to the printer 230 (step S1405). If a connection has been established between the command transmission/reception unit 224 and the printer 230 (YES in step S1405), the status information determination unit 225 determines that the print command generation unit 222 is generating the print command 223 (step S1406). If it is determined in step S1406 that the print command can be generated smoothly, a status (for example, a status information display screen 930 shown in FIG. 9C) is displayed so that the user can understand that a print command is being generated.

If no connection has been established between the command transmission/reception unit 224 and the printer 230 (NO in step S1405), the status information determination unit 225 determines that the printer 230 and print command generation unit 222 are in a normal status (step S1407).

By this processing, the status information display unit 226 can notify the user distinctively whether print command generation processing will delay. Even when no SDG command is generated immediately after the start of print processing, the determination is made based on a combination of identifiers saved in steps S1103 and S1212 (steps S1401 and S1405). The user can be notified that a print command is being generated.

According to the third embodiment, the user can determine whether processing within the printer driver 220 will be completed smoothly or will take longer time than usual.

In the third embodiment, when generation of a print command will take time, the SDG command is created, saved in data generation information, and confirmed by the status information determination unit 225. However, a resource large enough to mount such a determination unit may not be arranged. In such a case, for example, identifiers described in the embodiment are saved (steps S1103 and S1212), and only the save is determined (steps S1401 and S1405). In this case, after a display representing that a print command is being generated, if the print command has been transmitted to the printer successfully, the display may change to “printing in progress” by a well-known method. Even this method has a certain effect.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-013374, filed Jan. 25, 2011, which is hereby incorporated by reference herein in its entirety.

What is claimed is:

1. An information processing apparatus which communicates with a printer, comprising:
a print command generation unit configured to convert print data into a print command interpretable by the printer;
a status command generation unit configured to generate a status command representing a generation status of the print command by said print command generation unit;
a status command determination unit configured to determines the generation status of the print command based on the status command; and
a status display unit configured to display the generation status of the print command that has been determined by said status command determination unit.

2. The apparatus according to claim 1, further comprising a determination unit configured to determine, based on a condition defined in advance, whether generation of a print command will take time,
wherein when said determination unit determines that generation of the print command will take time, said status command generation unit generates a status command representing that generation of the print command will take time in said print command generation unit.

3. The apparatus according to claim 1, further comprising a transfer unit configured to transfer a command to the printer.

4. The apparatus according to claim 3, wherein said transfer unit transfers a status command generated by said status command generation unit to the printer.

5. The apparatus according to claim 1, further comprising:
a connection determination unit configured to determine a status of connection to the printer; and
a reception determination unit configured to determine whether the printer has received the print command,
wherein when said connection determination unit determines that the information processing apparatus is connected to the printer and said reception determination unit determines that the printer has received the print command, said status command determination unit determines that said print command generation unit is generating the print command.

6. The apparatus according to claim 1, wherein said status display unit acquires a status of the printer, and when the status of the printer is an error or printing in progress, displays an error or printing status preferentially to a status of said print command generation unit.

7. The apparatus according to claim 2, wherein when, as the condition, a sum of sizes of image data contained in print data is larger than a data size of a page to be printed or print data requires decoding processing, said determination unit determines that generation of the print command will take time.

8. A method of controlling an information processing apparatus which communicates with a printer, comprising:
a print command generation step of converting print data into a print command interpretable by the printer;
a status command generation step of generating a status command representing a generation status of the print command in the print command generation step;
a status command determination step of determining the generation status of the print command based on the status command; and
a status display step of displaying the generation status of the print command that has been determined in the status command determination step.

9. A computer-readable medium storing a program for causing a computer to function as
a print command generation unit configured to convert print data into a print command interpretable by a printer,
a status command generation unit configured to generate a status command representing a generation status of the print command by said print command generation unit,
a status command determination unit configured to determine the generation status of the print command based on the status command, and
a status display unit configured to display the generation status of the print command that has been determined by said status command determination unit.
